(19) United States
(12) Patent Application Publication
(10) Pub. No.: US 2022/0366549 A1
(43) Pub. Date: Nov. 17, 2022

(54) SYSTEM AND METHOD FOR AUTOMATIC ENHANCEMENT OF VIDEOS

(71) Applicants: LAKSHMINATH REDDY DONDETI, San Jose, CA (US); VIDYA NARAYANAN, San Jose, CA (US)

(72) Inventors: LAKSHMINATH REDDY DONDETI, San Jose, CA (US); VIDYA NARAYANAN, San Jose, CA (US)

(21) Appl. No.: 17/742,486

(22) Filed: May 12, 2022

Related U.S. Application Data
(60) Provisional application No. 63/188,028, filed on May 13, 2021.

(51) Int. Cl. G06T 5/00; H04N 5/262

(52) U.S. Cl. CPC G06T 5/007; H04N 5/2621; G06T 2207/10021

(57) ABSTRACT

Exemplary embodiments of the present disclosure are directed towards a system and method for automatic enhancement of videos, comprising a computing device configured to establish communication with server over network; a video creating module configured to enable a user to record video segments or upload a pre-recorded video segments or photos, the video creating module configured to allow the user to select an option processing template, the video creating module configured to transfer the user recorded video segments to server over network, server comprises automated video enhancement module configured to perform an audio analysis, a video analysis on the user recorded video segments, automated video enhancement module configured to detect contexts of the user recorded video segments on the computing device and applying templates to the user recorded video segments based on the results of the audio analysis, the video analysis, the contexts of the user recorded video segments.

### CROSS-REFERENCE TO RELATED APPLICATIONS

This patent application claims priority benefit of U.S. Provisional Patent Application No. 63/188,028, entitled “METHOD AND APPARATUS TO AUTOMATICALLY ENHANCE RECORDED VIDEOS WITH TEMPLATES THAT TRANSFORM THE VIDEO WITH A SEQUENCE OF FILTERS AND EFFECTS”, filed on 13 May 2021. The entire contents of the patent application are hereby incorporated by reference herein in its entirety.

### COPYRIGHT AND TRADEMARK NOTICE

This application includes material which is subject or may be subject to copyright and/or trademark protection. The copyright and trademark owner(s) have no objection to the facsimile reproduction by any of the patent disclosure, as it appears in the Patent and Trademark Office files or records, but otherwise reserves all copyright and trademark rights whatsoever.

### TECHNICAL FIELD

The disclosed subject matter relates generally to a system and method for enhancing a media recording. More particularly, the present disclosure relates automatically enhancing a user recorded video by applying tilt, zoom, filters, and other effects to improve the video's visual appeal.

### BACKGROUND

Generally, social media platform allows users to create, send, receive, and share various types of information, including user-generated content such as video clips. Because of their collaborative nature and growing accessibility, social media platforms such as social networks have become a popular means by which many people share videos and other media content.

Improvements in mobile phones with built-in cameras have enabled users to share video clips on social networks from any location. For instance, improved front-facing cameras in mobile phones allow users to capture high-quality videos. Mobile device applications (or apps) now provide various application features that work by interfacing with the device camera. Such device applications may allow taking and sharing videos. Some existing cameras have auto enhancements to fix photos and videos' lighting, sharpness, brightness, and smoothness. However, none of these change the camera angle, zoom, color filters, backgrounds, or other characteristics in videos. Some creation tools offer individual filters and effects that a creator may choose during the creation. However, none of these provide the ability to automatically combine filters and effects that come together contextually based on an audio track or video components.

In the light of the aforementioned discussion, there exists a need for a certain system for automatic enhancement of videos with novel methodologies that would overcome the above-mentioned challenges.

### SUMMARY

The following invention presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards a system and computer implemented method for automatic enhancement of videos.

Another objective of the present disclosure is directed towards enabling a user to create or record videos on a computing device.

Another objective of the present disclosure is directed towards enabling the user to upload offline recorded videos or photos on the computing device.

Another objective of the present disclosure is directed towards enabling the user to select an option post-processing template for automatic transformations of the video.

Another objective of the present disclosure is directed towards the terms ‘transformations’ and ‘templates’ refers to digital effects (tilt, zoom in, zoom out, flicker, rotation, visual effects), and may be interchangeably used; any methods that are stated to be applicable for transformations may also apply for templates and vice-versa.

Another objective of the present disclosure is directed towards applying digital effects to the video or photos based on a rhythm or a beat.

Another objective of the present disclosure is directed towards synchronizing the templates with portions of the user recorded video.

Another objective of the present disclosure is directed towards providing a mashup video using templates.

Another objective of the present disclosure is directed towards replacing the backgrounds of the user created video.

Another objective of the present disclosure is directed towards applying B-rolls at specific parts of the user created video.

Another objective of the present disclosure is directed towards applying perspective tilt, or angle to the user created video.

According to an exemplary aspect of the present disclosure, enabling the user to record video segments or upload a pre-recorded video segments or photos on a computing device by a video creating module.

According to another exemplary aspect of the present disclosure, allowing the user to select an option processing template by the video creating module.

According to another exemplary aspect of the present disclosure, transferring the user recorded video to a server by the video creating module over a network.

According to another exemplary aspect of the present disclosure, receiving the user recorded video by an automated video enhancement module enabled in the server.

According to another exemplary aspect of the present disclosure, performing an audio analysis and a video analysis on the user recorded video segments by the automated video enhancement module.

According to another exemplary aspect of the present disclosure, detecting contexts of the user recorded video segments by the automated video enhancement module.

According to another exemplary aspect of the present disclosure, applying templates to the user recorded video segments by the automated video enhancement module based on the results of the audio analysis, the video analysis, and the contexts of the user recorded video.

According to another exemplary aspect of the present disclosure, delivering the user recorded video segments with the applied templates to the computing device from the server over the network.

According to another exemplary aspect of the present disclosure, allowing the user to access the recorded video segments with the applied templates by the video creating module.

According to another exemplary aspect of the present disclosure, enabling the user to post the recorded video segments with the applied templates on the computing device by the video creating module.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a block diagram depicting a schematic representation of a system for automatic enhancement of videos, in accordance with one or more exemplary embodiments.

FIG. 2 is a block diagram depicting an embodiment of the video creating module 114 on the computing devices and the automated video enhancement module 116 on the server of shown in FIG. 1, in accordance with one or more exemplary embodiments.

FIG. 3 is a flow diagram depicting a method for automatic enhancement of videos, in accordance with one or more exemplary embodiments.

FIG. 4 is a flow diagram depicting a method for operational overview of the automated videos enhancement system shown in FIG. 1, in accordance with one or more exemplary embodiments.

FIG. 5 is a flow diagram depicting a method for enhancing the user created video, in accordance with one or more exemplary embodiments.

FIG. 6 is a flow diagram depicting a method for replacing backgrounds of the user created videos and creating remix videos, in accordance with one or more exemplary embodiments.

FIG. 7 is a block diagram illustrating the details of a digital processing system in which various aspects of the present disclosure are operative by execution of appropriate software instructions.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and so forth, herein do not denote any order, quantity, or importance, but rather are used to distinguish one element from another.

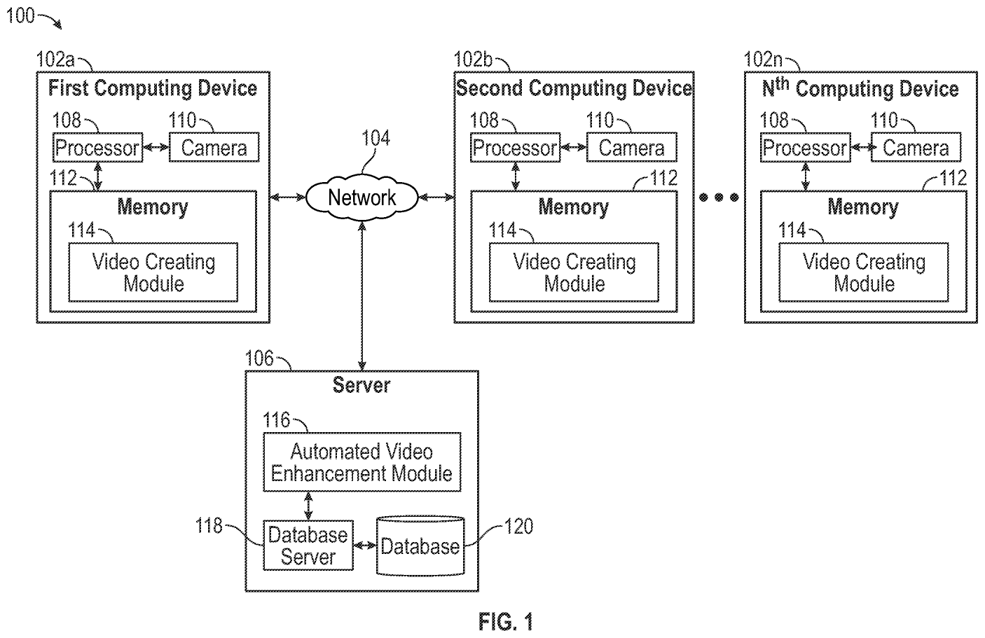

Referring to FIG. 1 is a block diagram 100 depicting a schematic representation of a system for automatic enhancement of videos, in accordance with one or more exemplary embodiments. The system 100 includes a first computing device 102a, a second computing device 102b, an nth computing 102n device, a network 104, a server 106, a processor 108, a camera 110, a memory 112, a video creating module 114, an automated video enhancement module 116, a database server 118, and a database 120.

The computing devices 102a, 102b, 102n may include users' devices. The computing devices 102a, 102b, 102n may include, but is not limited to, a personal digital assistant, smartphones, personal computers, a mobile station, computing tablets, a handheld device, an internet enabled calling device, an internet enabled calling software, a telephone, a mobile phone, a digital processing system, and so forth. The computing devices 102a, 102b, 102n may include the processor 108 in communication with a memory 112. The processor 108 may be a central processing unit. The memory 112 is a combination of flash memory and random-access memory.

The first computing device 102a or the second computing device 102b or the nth computing device 102n may be connected to the one or more computing devices and the server 106 via the network 104. The network 104 may include, but not limited to, an Internet of things (IoT network devices), an Ethernet, a wireless local area network (WLAN), or a wide area network (WAN), a Bluetooth low energy network, a ZigBee network, a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and so forth without limiting the scope of the present disclosure. The network 104 may be configured to provide access to different types of users.

Although the first computing device 102a or second computing device 102b or the nth computing device 102n is shown in FIG. 1, an embodiment of the system 100 may support any number of computing devices. The first computing device 102a or second computing device 102b or the nth computing device 102n may be operated by the users. The users may include, but not limited to, an individual, a client, an operator, a content creator, and the like. The first computing device 102a or second computing device 102b or the nth computing device 102n supported by the system 100 is realized as a computer-implemented or computer-based device having the hardware or firmware, software, and/or processing logic needed to carry out the computer-implemented methodologies described in more detail herein.

In accordance with one or more exemplary embodiments of the present disclosure, the computing devices 102a, 102b, 102n includes the camera 110 may be configured to enable the user to capture the multimedia objects using the processor 108. The multimedia objects may include, but not limited to photos, snaps, short videos, videos, looping videos, and the like. The computing devices 102a, 102b, 102n may include the video creating module 114 in the memory 112.

The video creating module 114 may be configured to enable the user to create or record video segments or upload pre-recorded video segments or photos on the computing device. The video creating module 114 may be any suitable applications downloaded from GOOGLE PLAY® (for Google Android devices), Apple Inc.'s APP STORE® (for Apple devices), or any other suitable database. The video creating module 114 may be desktop application which runs on Windows or Linux or any other operating system and may be downloaded from a webpage or a CD/USB stick etc. In some embodiments, the video creating module 114 may be software, firmware, or hardware that is integrated into the computing devices 102a, 102b, and 102n. The computing devices 102a, 102b, 102n may present a web page to the user by way of a browser, wherein the webpage comprises a hyper-link may direct the user to uniform resource locator (URL).

The server 106 may include the automated video enhancement module 116, the database server 118, and the database 120. The automated video enhancement module 116 may be configured to analyze the user created or recorded video. The automated video enhancement module 116 may be configured to detect contexts of the user created or recorded video. The automated video enhancement module 116 may also be configured to apply the templates to the user recorded video based on the analyzed results and contexts of the user created or recorded video. The automated video enhancement module 116 may also be configured to provide server-side functionality via the network 104 to one or more users. The database server 118 may be configured to access the one or more databases. The database 120 may be configured to store user created and recorded videos. The database 120 may also be configured to store interactions between the modules of the video creating module 114, and the automated video enhancement module 116.

In accordance with one or more exemplary embodiments of the present disclosure, the computing device may include the automated video enhancement module 116 may be configured to perform an audio analysis and a video analysis on the user recorded video segments.

In accordance with one or more exemplary embodiments of the present disclosure, the video creating module 114 may be configured to allow the user to select a post-processing, an inline-processing, a batch-processing options.

In accordance with one or more exemplary embodiments of the present disclosure, the templates may include the types of effects pan, zoom, tilt, rotate, combination of pan, zoom, tilt, and rotate at different speeds, focus, and angles.

In accordance with one or more exemplary embodiments of the present disclosure, the templates may include perspective tilt. The perspective tilt may lead a 3D rendering with one of the dimensions containing the camera output. The other dimensions may be filled with other videos or images or visual effects.

In accordance with one or more exemplary embodiments of the present disclosure, the templates may include the effects flicker (strobe effects) at different frequencies and speed, a dark frame (or other subtle transitions), front filters. The front filters may include spotlights, a confetti, flowers, a bokeh, a color, water drops or falls, snow at different levels of intensity, smoke, fog, shade, flash, shadows, and the like.

In accordance with one or more exemplary embodiments of the present disclosure, the templates effects may cover a small portion of the screen or the entire screen.

In accordance with one or more exemplary embodiments of the present disclosure, the templates effects may include a mirror (mirror the performers), silhouettes, B-roll images, or videos. The silhouettes may employ body extraction and transformation of the performers into silhouettes. The B-roll images or videos may include a few frames of other videos or images. The B-roll images or videos may be inserted into the user recorded video. The B-roll images or videos may be replacing the original footage to introduce transitions or contextual B-roll.

In accordance with one or more exemplary embodiments of the present disclosure, the templates effects may be applied to the B-roll images and videos. the templates effects may be applied to the user recorded video based on a rhythm or a beat (for example, applying a flicker based on a certain type of drumbeat).

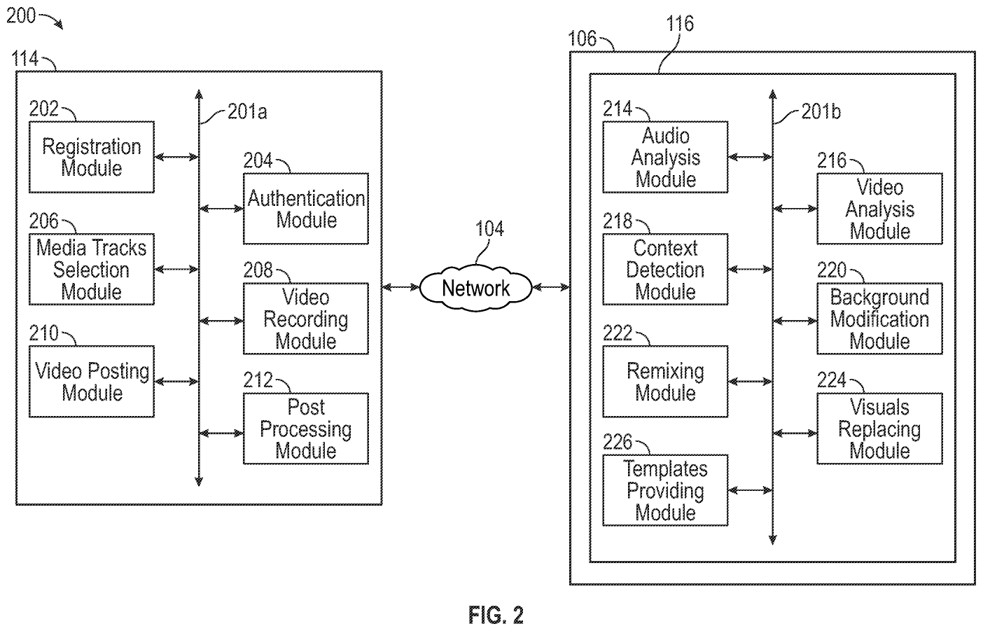

Referring to FIG. 2 is a block diagram 200 depicting an embodiment of the video creating module 114 on the computing devices and the automated video enhancement module 116 on the server of shown in FIG. 1, in accordance with one or more exemplary embodiments. The video creating module 114 includes a bus 201a, a registration module 202, an authentication module 204, a media tracks selection module 206, a video recording module 208, a video posting module 210, a post processing module 212. The bus 201a may include a path that permits communication among the modules of the content creation module 114 installed on the computing devices 102a, 102b, 102n. The term “module” is used broadly herein and refers generally to a program resident in the memory 112 of the computing devices 102a, 102b, 102n.

The registration module 202 may be configured to enable the user to register on the video creating module 114 installed on the computing devices by providing basic details of the user. The registration module 202 may be configured to enable the user to access the video creating module 114 installed on the computing devices. The authentication module 204 may be configured to enable the user to login and access the video creating module 114 installed on the computing devices using a user identity of the user. The media tracks selection module 206 may be configured to display the available media tracks on the track screen. The media tracks selection module 206 may be configured to allow the user to access and select the media tracks for creating or recording the video segments. The video recording module 208 may be configured to enable the user to tap a camera icon to record the video segments using the media tracks. The video posting module 210 may be configured to enable the user to post the recorded video with the applied templates. The post processing module 212 may be configured to allow the user to select a processing template option to enhance the video segments automatically.

In accordance with one or more exemplary embodiments of the present disclosure, the automated video enhancement module 116 includes a bus 201b, an audio analysis module 214, a video analysis module 216, a context detection module 218, a background modification module 220, a remixing module 222, a visuals replacing module 224, a templates providing module 226.

The bus 201b may include a path that permits communication among the modules of the automated video enhancement module 116 installed on the sever 106.

In accordance with one or more exemplary embodiments of the present disclosure, the audio analysis module 214 may be configured to perform an audio analysis on the user recorded video segments. The video analysis module 216 may be configured to perform a video analysis on the user recorded video segments. The context detection module 218 may be configured to detect contexts of the user recorded video segments. The background modification module 220 may be configured to replace backgrounds of the user recorded video. The background modification module 220 may be configured to allow the background to match with an original professional video as well. The remixing module 222 may be configured to generate a remix video using the one or more other video segments and the templates. The remix video may be a mashup with one or more other videos, the one of the other videos may be an original music video or some other professional video for example the user performing to a popular media track may remix their video with the original music video of that media track itself. The visuals replacing module 224 may be configured to apply the B-rolls on the specific parts of the user recorded video segments. The B-rolls may include contextual images or short videos that relate to the lyrics (in the case of a music video) or the video context. For example, a village scene may be part of a template applied to a scene that describes rural living or the image of a celebrity may be applied to the part of the video that refers to that name, and the like. The templates providing module 226 may be configured to apply the templates to the user recorded video segments. The template may include the perspective tilt or the angle in this rendering, the video plane may be projected on a three-dimensional object-e.g., one of the walls in a virtual room. The other dimensions (e.g., walls, floor) may contain other contextual images or videos or other visual effects. The templates may be used to bring motion to an otherwise mostly stationary video such as a talk show.

In accordance with one or more exemplary embodiments of the present disclosure, the templates effects may be synchronized to portions of the user recorded video segments. For example, the effects may mimic an original music video may be synchronized to the corresponding positions on the media tracks. This may allow the same style of lighting or zooming or confetti, and the like.

In accordance with one or more exemplary embodiments of the present disclosure, after applying templates to the user recorded video multiple videos may be combined to create the final experience. For example, a sequence of front filters recorded as the video that lasts for a certain duration may be combined with the original videos.

In accordance with one or more exemplary embodiments of the present disclosure, the templates that are synchronized to specific tracks may also be applied on the user recorded videos that may use other media tracks.

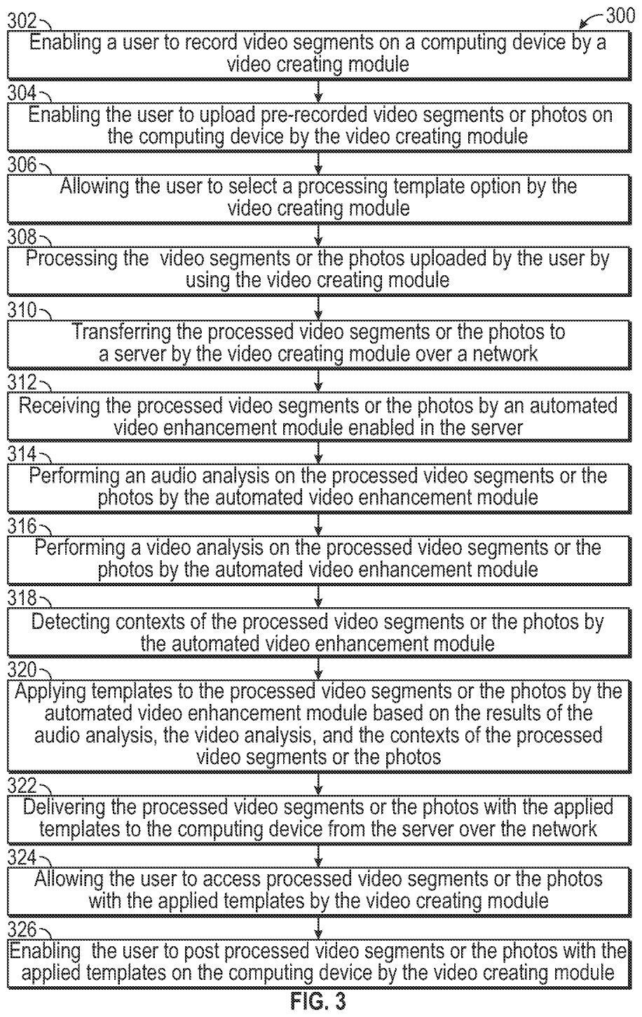

Referring to FIG. 3 is a flow diagram 300 depicting a method for automatic enhancement of videos, in accordance with one or more exemplary embodiments. The method 300 may be carried out in the context of the details of FIG. 1, and FIG. 2. However, the method 300 may also be carried out in any desired environment. Further, the aforementioned definitions may equally apply to the description below.

The method commences at step 302, enabling the user to record video segments on a computing device by the video creating module. Thereafter at step 304, enabling the user to upload pre-recorded video segments or photos on the computing device by the video creating module. Thereafter at step 306, allowing the user to select the processing template option by the video creating module. Thereafter at step 308, processing the video segments or the photos uploaded by the user by using the video creating module. Thereafter at step 310, transferring the processed video segments or the photos to the server by the video creating module over the network. Thereafter at step 312, receiving the processed video segments or the photos by the automated video enhancement module enabled in the server. Thereafter at step 314, performing the audio analysis on the processed video segments or the photos by the automated video enhancement module. Thereafter at step 316, performing the video analysis on the processed video segments or the photos by the automated video enhancement module. Thereafter at step 318, detecting contexts of the processed video segments or the photos by the automated video enhancement module. Thereafter at step 320, applying templates to the processed video segments or the photos by the automated video enhancement module based on the results of the audio analysis, the video analysis, and the contexts of the processed video segments or the photos. Thereafter at step 322, delivering the processed video segments or the photos with the applied templates to the computing device from the server over the network. Thereafter at step 324, allowing the user to access processed video segments or the photos with the applied templates by the video creating module. Thereafter at step 326, enabling the user to post the processed video segments or the photos with the applied templates on the computing device by the video creating module.

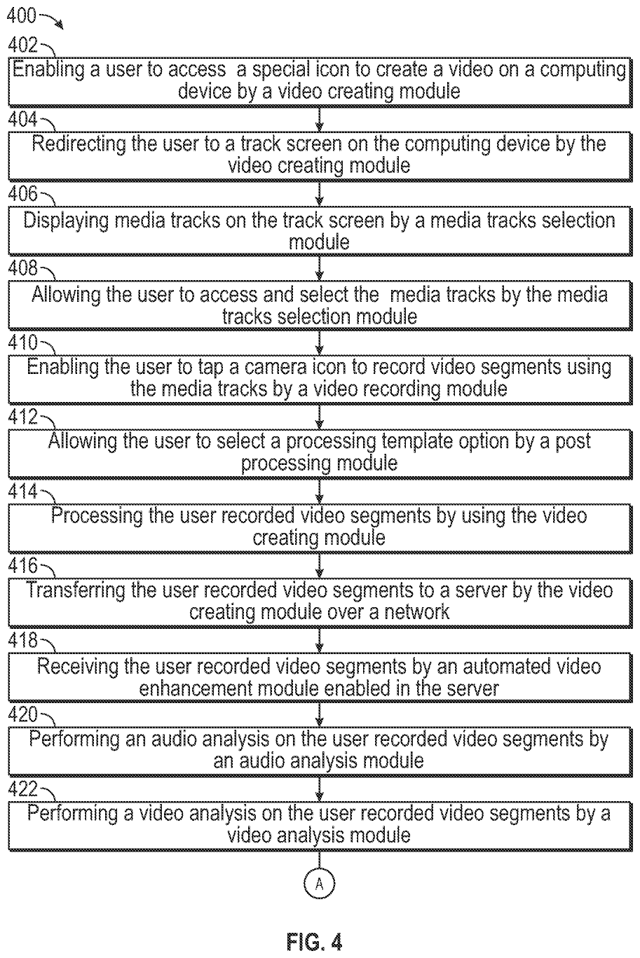

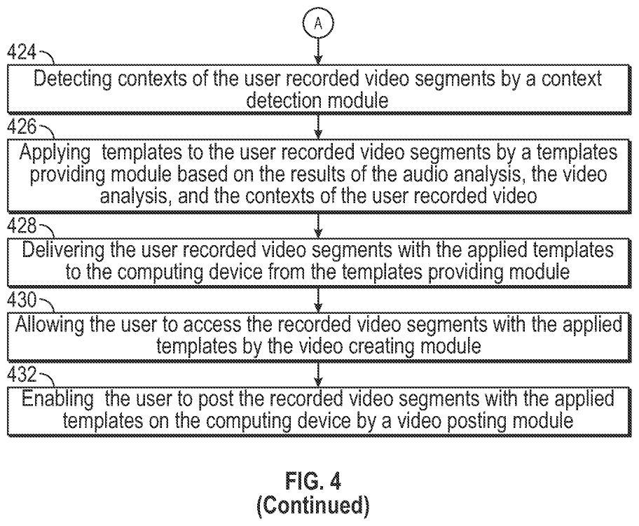

Referring to FIG. 4 is a flow diagram 400 depicting a method for operational overview of the automated videos enhancement system shown in FIG. 1, in accordance with one or more exemplary embodiments. The method 400 may be carried out in the context of the details of FIG. 1, FIG. 2, and FIG. 3. However, the method 400 may also be carried out in any desired environment. Further, the aforementioned definitions may equally apply to the description below.

The method commences at step 402, enabling the user to access a special icon to create a video on a computing device by the video creating module. Thereafter at step 404, redirecting the user to the track screen on the computing device by the video creating module. Thereafter at step 406, displaying media tracks on the track screen by the media tracks selection module. Thereafter at step 408, allowing the user to access and select the media tracks by the media tracks selection module. Thereafter at step 410, enabling the user to tap the camera icon to record the video segments using the media tracks by the video recording module. Thereafter at step 412, allowing the user to select the processing template option by the post processing module. Thereafter at step 414, processing the user recorded video segments by using the video creating module. Thereafter at step 416, transferring the user recorded video segments to the server by the video creating module over the network. Thereafter at step 418, receiving the user recorded video segments by the automated video enhancement module enabled in the server. Thereafter at step 420, performing the audio analysis on the user recorded video segments by the audio analysis module. Thereafter at step 422, performing the video analysis on the user recorded video segments by the video analysis module. Thereafter at step 424, detecting the contexts of the user recorded video segments by the context detection module. Thereafter at step 426, applying the templates to the user recorded video segments by the templates providing module based on the results of the audio analysis, the video analysis, and the contexts of the user recorded video. Thereafter at step 428, delivering the user recorded video segments with the applied templates to the computing device from the templates providing module. Thereafter at step 430, allowing the user to access the recorded video segments with the applied templates by the video creating module. Thereafter at step 432, enabling the user to post the recorded video segments with the applied templates on the computing device by a video posting module.

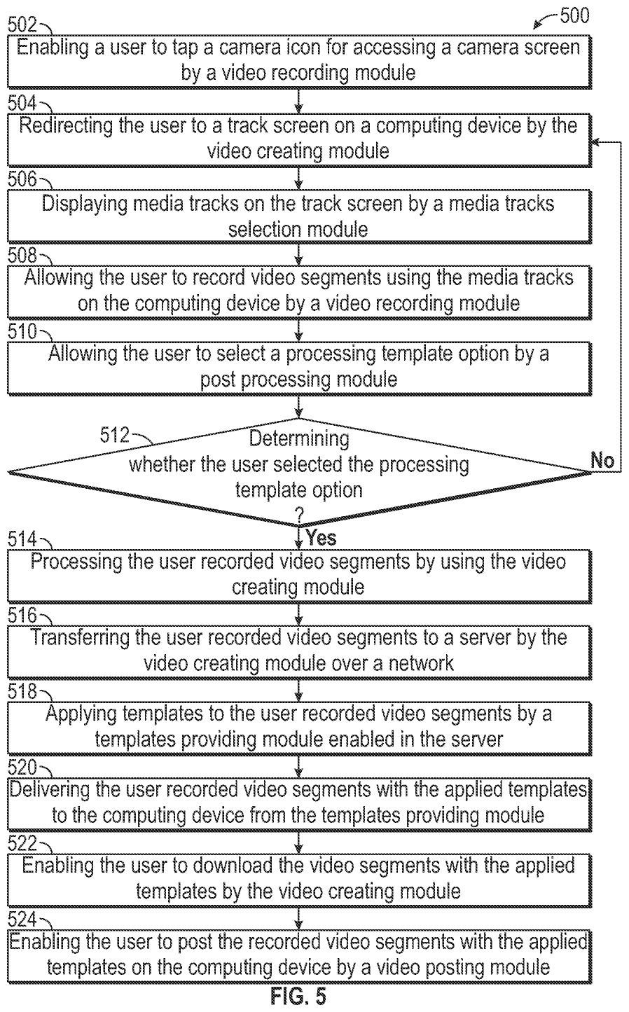

Referring to FIG. 5 is a flow diagram 500 depicting a method for enhancing the user created video, in accordance with one or more exemplary embodiments. The method 500 may be carried out in the context of the details of FIG. 1, FIG. 2, FIG. 3, and FIG. 4. However, the method 500 may also be carried out in any desired environment. Further, the aforementioned definitions may equally apply to the description below.

The method commences at step 502, enabling the user to tap the camera icon for accessing the camera screen by the video recording module. Thereafter at step 504, redirecting the user to the track screen on the computing device by the video creating module. Thereafter at step 506, displaying the media tracks on the track screen by the media tracks selection module. Thereafter at step 508, allowing the user to record the video segments using the media tracks on the computing device by the video recording module. Thereafter at step 510, allowing the user to select the processing template option by the post processing module. Determining whether the user selected the processing template option, at step 512. If answer at step 512 is Yes, the method continues at step 514, processing the user recorded video segments by using the video creating module. Thereafter at step 516 transferring the user recorded video segments to the server by the video creating module over the network. Thereafter at step 518, applying the templates to the user recorded video segments by the templates providing module enabled in the server. Thereafter at step 520, delivering the user recorded video segments with the applied templates to the computing device from the templates providing module. Thereafter at step 522, enabling the user to download the video segments with the applied templates by the video creating module.

Thereafter at step 524, enabling the user to post the recorded video segments with the applied templates on the computing device by the video posting module. If answer at step 512 is No, the method reverts at step 504.

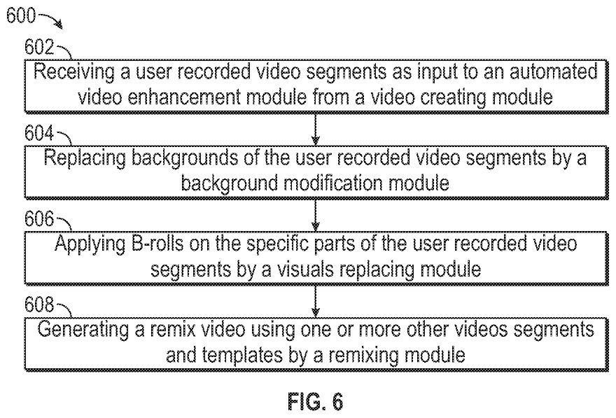

Referring to FIG. 6 is a flow diagram 600 depicting a method for replacing backgrounds of the user created videos and creating remix videos, in accordance with one or more exemplary embodiments. The method 600 may be carried out in the context of the details of FIG. 1, FIG. 2, FIG. 3, FIG. 4, and FIG. 5. However, the method 600 may also be carried out in any desired environment. Further, the aforementioned definitions may equally apply to the description below.

The method commences at step 602, receiving the user recorded video segments as input to the automated video enhancement module from the video creating module. Thereafter at step 604, replacing the backgrounds of the user recorded video segments by the background modification module. Thereafter at step 606, applying b-rolls on the specific parts of the user recorded video segments by the visuals replacing module. Thereafter at step 608, generating the remix video using one or more other video segments and the templates by the remixing module.

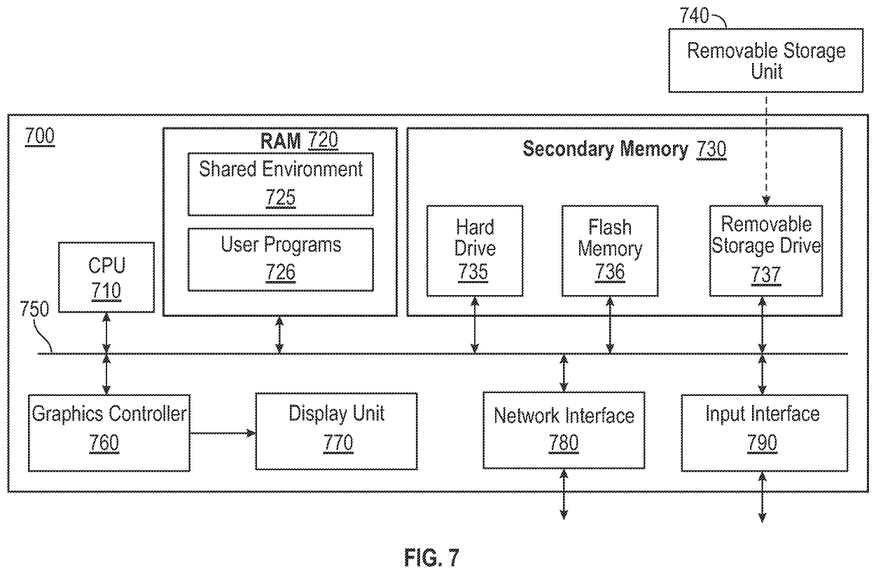

Referring to FIG. 7 is a block diagram 700 illustrating the details of a digital processing system 700 in which various aspects of the present disclosure are operative by execution of appropriate software instructions. The Digital processing system 700 may correspond to the computing devices 102a, 102b, 102n (or any other system in which the various features disclosed above can be implemented).

Digital processing system 700 may contain one or more processors such as a central processing unit (CPU) 710, random access memory (RAM) 720, secondary memory 730, graphics controller 760, display unit 770, network interface 780, and input interface 790. All the components except display unit 770 may communicate with each other over communication path 750, which may contain several buses as is well known in the relevant arts. The components of FIG. 7 are described below in further detail.

CPU 710 may execute instructions stored in RAM 720 to provide several features of the present disclosure. CPU 710 may contain multiple processing units, with each processing unit potentially being designed for a specific task. Alternatively, CPU 710 may contain only a single general-purpose processing unit.

RAM 720 may receive instructions from secondary memory 730 using communication path 750. RAM 720 is shown currently containing software instructions, such as those used in threads and stacks, constituting shared environment 725 and/or user programs 726. Shared environment 725 includes operating systems, device drivers, virtual machines, etc., which provide a (common) run time environment for execution of user programs 726.

Graphics controller 760 generates display signals (e.g., in RGB format) to display unit 770 based on data/instructions received from CPU 710. Display unit 770 contains a display screen to display the images defined by the display signals. Input interface 790 may correspond to a keyboard and a pointing device (e.g., touch-pad, mouse) and may be used to provide inputs. Network interface 780 provides connectivity to a network (e.g., using Internet Protocol), and may be used to communicate with other systems (such as those shown in FIG. 1) connected to the network 104.

Secondary memory 730 may contain hard drive 735, flash memory 736, and removable storage drive 737. Secondary memory 730 may store the data software instructions (e.g., for performing the actions noted above with respect to the Figures), which enable digital processing system 700 to provide several features in accordance with the present disclosure.

Some or all of the data and instructions may be provided on removable storage unit 740, and the data and instructions may be read and provided by removable storage drive 737 to CPU 710. Floppy drive, magnetic tape drive, CD-ROM drive, DVD Drive, Flash memory, removable memory chip (PCMCIA Card, EEPROM) are examples of such removable storage drive 737.

Removable storage unit 740 may be implemented using medium and storage format compatible with removable storage drive 737 such that removable storage drive 737 can read the data and instructions. Thus, removable storage unit 740 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 740 or hard disk installed in hard drive 735. These computer program products are means for providing software to digital processing system 700. CPU 710 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 730. Volatile media includes dynamic memory, such as RAM 720. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (communication path) 750. Transmission media can also take the form of acoustic or light waves, such as those generated during radio-wave and infra-red data communications.

According to an exemplary aspect of the present disclosure, enabling a user to record one or more video segments or upload one or more pre-recorded video segments on a computing device by a video creating module 114.

According to an exemplary aspect of the present disclosure, allowing the user to select a processing template option by the video creating module 114.

According to an exemplary aspect of the present disclosure, processing the one or more video segments or the one or more photos uploaded by the user by using the video creating module 114

According to an exemplary aspect of the present disclosure, transferring the processed one or more video segments or the one or more photos to a server 106 by the video creating module 114 over a network 104.

According to an exemplary aspect of the present disclosure, receiving the processed one or more video segments or the one or more photos by an automated video enhancement module 116 enabled in the server 106.

According to an exemplary aspect of the present disclosure, performing an audio analysis and a video analysis on the one or more video segments or the one or more photos by the automated video enhancement module 116.

According to an exemplary aspect of the present disclosure, detecting contexts of the one or more video segments or the one or more photos by the automated video enhancement module 116.

According to an exemplary aspect of the present disclosure, applying one or more templates to the one or more video segments or the one or more photos by the automated video enhancement module 116 based on the results of the audio analysis, the video analysis, and the contexts of the one or more video segments or the one or more photos.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

What is claimed is:

1. A method for automatic enhancement of videos, comprising:
enabling a user to record one or more video segments or upload one or more pre-recorded video segments on a computing device by a video creating module;
allowing the user to select a processing template option by the video creating module;
processing the one or more video segments or the one or more photos uploaded by the user by using the video creating module;
transferring the processed one or more video segments or the one or more photos to a server by the video creating module over a network;
receiving the processed one or more video segments or the one or more photos by an automated video enhancement module enabled in the server;
performing an audio analysis and a video analysis on the one or more video segments or the one or more photos by the automated video enhancement module;
detecting contexts of the one or more video segments or the one or more photos by the automated video enhancement module;
applying one or more templates to the one or more video segments or the one or more photos by the automated video enhancement module based on the results of the audio analysis, the video analysis, and the contexts of the one or more video segments or the one or more photos;
delivering the one or more video segments or the one or more photos with the one or more applied templates to the computing device from the server over the network;
allowing the user to access the one or more video segments or the one or more photos with the one or more applied templates by the video creating module; and
enabling the user to post the one or more video segments or the one or more photos with the one or more applied templates on the computing device by the video creating module.

2. The method of claim 1, comprising a step of enabling the user to access a special icon to record the one or more video segments on the computing device by the video creating module.

3. The method of claim 2, comprising a step of redirecting the user to a track screen on the computing device by the video creating module.

4. The method of claim 3, comprising a step of displaying one or more media tracks on the track screen by a media tracks selection module.

5. The method of claim 4, comprising a step of allowing the user to access and select the one or more media tracks by the media tracks selection module.

6. The method of claim 5, comprising a step of enabling the user to tap a camera icon to record the one or more video segments using the one or more media tracks by a video recording module.

7. The method of claim 1, comprising a step of allowing the user to select a post-processing, an inline-processing, a batch-processing options using the video creating module.

8. The method of claim 1, comprising a step of enhancing the user recorded one or more video segments automatically by the automated video enhancement module.

9. The method of claim 1, comprising a step of analyzing a beat, frequency mapping, sound energy levels, loudness, and variability of the user recorded one or more video segments by an audio analysis module.

10. The method of claim 1, comprising a step of analyzing audio tracks, videos, images, objects, scenes, gestures of the user recorded one or more video segments by a video analysis module.

11. The method of claim 1, comprising a step of detecting contexts of the user recorded one or more video segments by a context detection module.

12. The method of claim 1, comprising a step of applying the one or more templates with a composite series of multi-layered audio and video effects to the user recorded one or more video segments by a templates providing module.

13. The method of claim 1, comprising a step of enabling the user to download the one or more video segments with the one or more applied templates by the video creating module.

14. The method of claim 1, comprising a step of enabling the user to post the downloaded one or more video segments with the one or more applied templates on the computing device by a video posting module.

15. The method of claim 12, wherein the one or more templates comprises pan, zoom, tilt, rotate, a combination of pan, zoom, tilt, and rotate at different speeds, focus, and angles.

16. The method of claim 12, comprising a step of applying B-rolls, or a set of pictures with animated effects as a full screen replacement or applying B-rolls, or a set of pictures with animated effects as a partial screen display by a visuals replacing module.

17. The method of claim 12, comprising a step of replacing backgrounds of the user recorded one or more video segments by a background modification module.

18. The method of claim 12, comprising a step of generating a remix video using the one or more other segments and the one or more templates by a remixing module.

19. A system for automatic enhancement of videos, comprising:
a computing device configured to establish communication with a server over a network, whereby the computing device comprises a memory configured to store multimedia objects captured using a camera;
the computing device comprises a video creating module configured to enable a user to record one or more video segments or upload one or more pre-recorded video segments or photos, whereby the video creating module configured to allow the user to select a processing template option, the video creating module configured to transfer the user recorded video to the server over the network; and
the server comprises an automated video enhancement module configured to perform an audio analysis and a video analysis on the user recorded one or more video segments, whereby the automated video enhancement module configured to detect contexts of the user recorded one or more video segments on the computing device and applying one or more templates to the user recorded one or more video segments based on the results of the audio analysis, the video analysis, and the contexts of the user recorded video.

20. A computer program product comprising a non-transitory computer-readable medium having a computer-readable program code embodied therein to be executed by one or more processors, said program code including instructions to:
enable a user to record one or more video segments or upload one or more pre-recorded video segments or photos on a computing device by a video creating module;
allow the user to select a processing template option by the video creating module;
process the one or more video segments or the one or more photos uploaded by the user by using the video creating module;
transfer the processed one or more video segments or the one or more photos to a server by the video creating module over a network;
receive the processed one or more video segments or the one or more photos by an automated video enhancement module enabled in the server;
perform an audio analysis and a video analysis on the one or more video segments or the one or more photos by the automated video enhancement module;
detect contexts of the one or more video segments or the one or more photos by the automated video enhancement module;
apply one or more templates to the one or more video segments or the one or more photos by the automated video enhancement module based on the results of the audio analysis, the video analysis, and the contexts of the one or more video segments or the one or more photos;
deliver the one or more video segments or the one or more photos with the one or more applied templates to the computing device from the server over the network;
allow the user to access the one or more video segments or the one or more photos with the one or more applied templates by the video creating module; and
enable the user to post the one or more video segments or the one or more photos with the one or more applied templates on the computing device by the video creating module.
